(19) United States
(12) Patent Application Publication
(10) Pub. No.: US 2018/0118299 A1
(43) Pub. Date: May 3, 2018

(54) FOLDABLE, PERSONAL, TRANSPORTATION DEVICE

(71) Applicant: Hui Lu, Wenlin (CN)

(72) Inventor: Hui Lu, Wenlin (CN)

(21) Appl. No.: 15/412,733

(22) Filed: Jan. 23, 2017

(30) Foreign Application Priority Data
Oct. 27, 2016 (CN) 201610959235.2.

(51) Int. Cl. B62K 15/00; B62K 3/00; B62K 21/16

(52) U.S. Cl. CPC B62K 15/008; B62K 2202/00; B62K 21/16; B62K 3/002

(57) ABSTRACT

The invention is a foldable, personal transportation device. It can be ridden either by manual propulsion, that is, pushing backward with a foot on the ground while standing with the other foot on the riding platform. It may also be used with electric motor propulsion. When folded, the device is free standing. It can also be pulled, while remaining on the ground, in its folded state.

### TECHNICAL FIELD

This invention is associated with manually propelled and electrically propelled scooters.

### BACKGROUND OF THE INVENTION

Increasingly, adults, young adults and teenagers are using personal transportation devices, such as scooters and skateboards, to travel from home to a mass transportation stop. They then fold the device and board the bus or train. Upon arrival, they will unfold the device and continue traveling to their destination.

With regard to scooters, the riding platform is typically a unibody construction and upon arrival at a transportation kiosk, the user can fold the steering column so that it meets the riding platform, but the dimensions make it such that the user will have to carry the device until it is time to unfold and ride it, again. Alternatively, a user could put the scooter on the floor of the bus or train, but that entails risk of other passengers stumbling over it.

### BRIEF SUMMARY OF THE INVENTION

The invention disclosed and claimed herein is a folding scooter device in which the riding platform as well as the steering column can be folded such that when fully folded, the device can be pulled with its wheels along the ground until such time as the user decides to unfold and ride it, again. A user can also place the folded scooter in a free-standing stationary position where it takes up less space and reduces the chance of another passenger stumbling over it.

The device invention is designed so that when folded, the front and rear wheels align next to one another, with or without space between these wheels which are now parallel, allowing the folded riding platform to be more fully folded. What's more, when fully folded, the wheels and a combination of foot folding lever and base allows the folded scooter to stand on its edge, freely. When the user wants to move it somewhere else, the user can opt to simply grasp the handle bar, tilt the folded device forward, and pull it so that the wheels engage the ground surface and allow the device to roll in the direction it is being pulled.

The folding features of the device allow one to fold it without having to remove it from the ground. Stepping down on the foot folding lever and stand, located on the back end of scooter, releases locking mechanisms on the steering column platform mounting and the hinging subsystem, located along the mating edges. The pushing-motion momentum will force the back half of the platform to move forward on the rear wheel or wheels until both half platforms contact each other. When fully folded, both locking mechanisms on the steering column platform mounting and the hinging subsystem along the mating edges will lock in the fully locked positon. Later, when ready to unfold it, it may also be unfolded without having to lift it off the ground by stepping down on the same foot folding lever and stand. This releases locking mechanisms on the steering column platform mounting and the hinging subsystem along the mating edges, Then, a user pushes the head of steering column backward so the front half of the platform will move forward and the two half platforms will move apart as the front and rear wheels rotate in opposite directions until both half platforms are in same plane. At that point, the locking mechanism will lock the half platforms into the fully unfolded position.

The ease and speed with which the device can folded and unfolded means one can quickly fold it when needing to hurry to board a bus or train. Furthermore, because it can be pulled instead of carried, it applies less strain on the user when having to transport it in the folded state. In addition it can stand up on its own on the floor of a bus or train, having a small footprint and minimizing the chance of another passenger stumbling over it.

### BRIEF DESCRIPTIONS OF THE DRAWINGS

FIG. 1 depicts one embodiment of the device shown from a bottom view.

FIG. 2 depicts the embodiment of FIG. 1 from a top view.

FIG. 3 depicts the embodiment of FIG. 1 from a side view.

FIG. 4 depicts the embodiment of FIG. 1 from a front view.

FIG. 5 illustrates how the device folding process is initiated.

FIG. 6 illustrates the folding process nearly completed

FIG. 7 illustrates a completely folded device standing on its own.

FIG. 8 illustrates how the device can be pulled while still making contact with the ground.

FIG. 9 illustrates how the device is unfolded using only a hand on the handle bar.

FIG. 10 shows the device fully unfolded.

FIG. 11 shows another embodiment of the device with a different configuration of the platform portions and mating edges that enables the portions to rotate past one another in order to bring the wheels into essentially side-by-side alignment.

FIG. 12 is a side view of the embodiment of FIG. 11.

FIG. 13 is another embodiment of the device in a different configuration of the platform portion and mating edges that enables the portions to rotate past one another in order to bring the wheels into essentially side-by-side alignment.

FIG. 14 is side view of the embodiment of FIG. 13

FIG. 15 shows the folded rearward and forward portions of the embodiment of FIG. 11 now rotated into an essentially vertical position such that the wheels and foot folding lever and stand provide firm footing allowing the device to stand on its own.

FIG. 16 is a front view of the folded device based on the embodiment of FIG. 11.

FIG. 17 is a front view of the folded device based on the embodiment of FIG. 13.

FIG. 18 is an embodiment where the wheels have a large diameter but the riding platform remains low to the ground surface.

FIG. 19 shows the embodiment of FIG. 18 fully folded and locked into position.

### DETAILED DESCRIPTION OF INVENTION

Increasingly adults, young adults and teenagers are using personal transportation devices, such as scooters and skateboards, to travel from home to a mass transportation stop. Once there, they will fold the transportation device (if it is foldable) and board the bus or train. Then, when arriving at a destination stop, they will exit the bus or train, and either carry or unfold and ride the transportation device.

Most skateboards do not fold and must be carried. Scooters, in many cases, have steering columns that can be folded down against the riding platform, but dimensions often dictate that the user will have to carry the device until such time as it can be unfolded and ridden, again.

The invention hereby disclosed and claimed is a personal transportation scooter-like device that can be folded in such a way as to enable it to be pulled along in a folded state until such time that the user can unfold and ride it, again. In addition, in its folded orientation, the device is free standing, taking up little space, and reducing the risk of someone tripping over it.

As shown in FIG. 1, in a first embodiment of the device, the riding platform consists of two portions, P₁ and P₂, that are joined at mating edges by a hinging subsystem 106. The hinging subsystem divides the riding platform into the two portions. When unfolded, the riding platform is essentially a rectangular structure with a top surface, a bottom surface, peripheral side edges 110, a peripheral front edge 111, and a peripheral rear edge 112. At least one wheel 101 is located just forward of the peripheral front edge, and a rear wheel or wheels 113 is located on the bottom surface near the peripheral rear edge. If larger wheel or wheels are used for smoother riding, the riding platform should still be low to the ground so that a user can still easily step on. Also, the riding will be more stable because the center of gravity will be lower. Therefore, the larger wheels may have a portion that sits above the platform's top surface in a slot in the middle of rearward portion. A platform mounting bracket 102 serves to connect the steering column 104, forward wheel 101, and wheel mounting hardware to the forward portion such that the bracket is connected to the forward portion near the peripheral front edge, and the wheel or wheels, steering column 104 and steering column sleeve 114 are located past the peripheral front edge with the wheel extending below the bottom surface, or in front of the peripheral front edge. The steering column together with the mounted front wheel or wheels can rotate inside the steering column sleeve rigidly attached to the platform mounting bracket. The rear wheel or wheels 113 and its mounting hardware are affixed to the rearward portion near the peripheral rear edge. The mounting hardware may have an extendable mechanism that pushes down and locks while the riding platform is stepped on. As such, the platform is low and easy for a user to step up on. When folding, after a user has stepped off, the mounting hardware will return to its original height. Thus, both front and rear wheel, or wheels, can be side-by-side when folded. On the top surface, near the peripheral rear edge and mid-way between the peripheral side edges is a structure called a “foot folding lever and stand,” 105. A locking subsystem 116 automatically locks the steering column into a near vertical position, when the device is unfolded. Furthermore, when the device is folded completely, the locking subsystem 116 will automatically lock the steering column in a position essentially parallel with the now folded front half board P1. Later, when being folded, an unlocking actuator 118 is activated by pressure on the foot folding lever and stand, and the unlocking actuator unlocks the locking subsystem 116. The two portions (P₁ and P₂) are joined at their mating edges such that when they are unfolded, they form a coplanar riding platform that is essentially rectangular with length, L, and width, W, where L is at least 23 inches and W is at least 4 inches. Holding the portions together is a hinging subsystem aligned along the mating edges. The line of the edges makes an angle, Φ, with a line perpendicular to the peripheral side edges. When the two portions are folded, instead of lining up with one another, their respective peripheral front and rear edges will be laterally displaced, as a result of the angular displacement of the mating edges. As a result, the front and rear wheel or wheels will end up essentially side-by-side rather than meeting edge on, with or without a small space between them, so as to enable the device to stand up securely. This allows the portions to fold more completely and allows the wheels to be free to turn when the device is being pulled. A locking subsystem 115 in the middle of riding platform automatically locks the two portions into their coplanar orientation when the device is fully unfolded. An unlocking actuator 117, activated by pressure on the foot folding lever and stand will unlock the locking subsystem 115. As shown in FIG. 1, the unlocking actuators 116 and 117 are routed through channels that run through the interior, or along the bottom of the forward and rearward portions. These are connected to the foot folding lever and stand. Pressure on the foot folding lever and stand, when the device is either fully folded or fully unfolded, will unlock the locking subsystems 115 and 116.

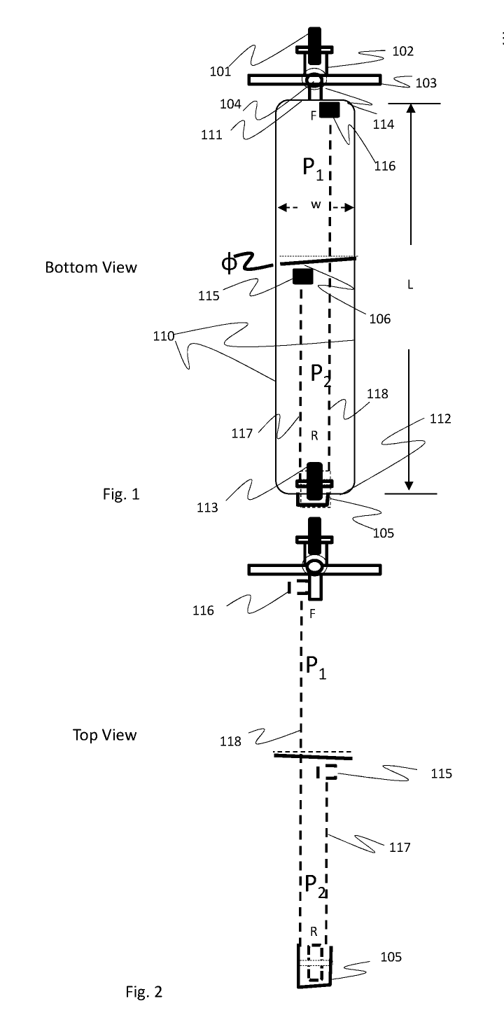

FIG. 2 shows a top view of the embodiment of the device. Mounted to the rearward portion, near the peripheral rear edge is the foot folding lever and stand 105. Note that it extends past the peripheral rear edge. When pressed on by a user's foot, the foot folding lever and stand applies pressure to unlocking actuators 117 and 118 which in turn unlock the locking subsystems 115 and 116 when the device is either fully folded or fully unfolded.

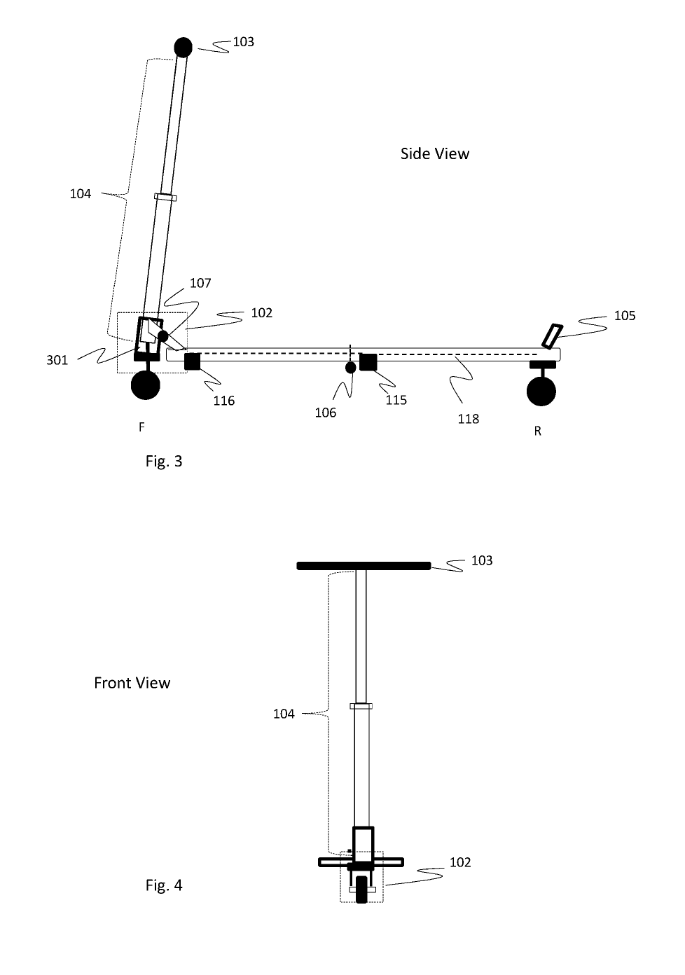

FIG. 3 provides a side view of the unfolded device embodiment. The steering handlebar 103 sits atop the length-adjustable steering column 104 and the platform mounting bracket subsystem 102 comprises the bracket, a bracket hinge 107, and a steering column sleeve 301. The platform mounting bracket is operative to allow the steering subsystem to fold essentially parallel to the top surface of the platform by rotating on hinge 107. In line with the mating edges, a hinging subsystem 106 enables the forward and rearward portions to fold such that the bottom surfaces can move toward one another. The foot folding lever and stand 105 is shown from the side, near the peripheral rear edge with its upper portion extending just past the peripheral rear edge. In addition, the locking subsystems 115 and 116, and the unlocking actuator 118 are shown. The unlocking actuator 117 (not shown) is behind unlocking actuator 118.

FIG. 4 provides a front view of the device embodiment. The steering handlebar 103 is mounted atop the steering column 104 such that when it is turned in essentially a horizontally oriented plane, the steering column and wheel will also rotate, enabling steering of the front wheel or wheels.

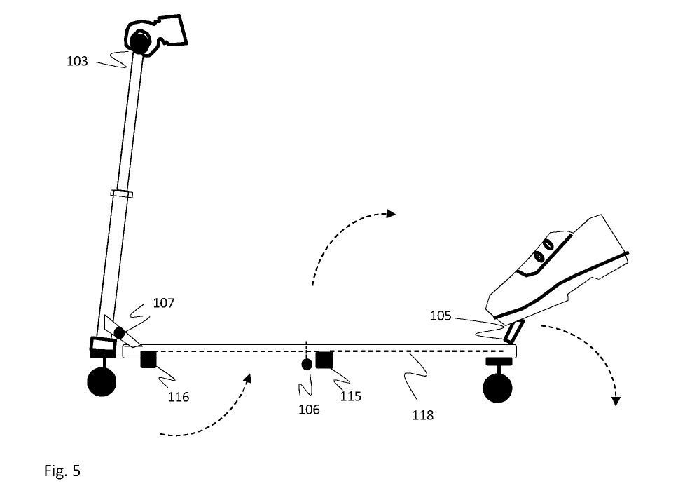

A user folds the device embodiment, as shown in FIG. 5, by pressing down with one's foot on the foot folding lever and stand 105 while holding the steering handlebar 103 in its current position. The foot press causes the rearward portion and forward portion to rotate upward at the mating edges 106 because of the hinging subsystem located at that line. The platform mounting bracket's hinging subsystem 107 allows the steering column to remain upright as the forward portion rotates due to the foot pressing on the foot folding lever. Pressing on the foot folding lever and stand also simultaneously activates the unlocking actuators 117 and 118 thereby unlocking the locking subsystems 115 and 116, respectively

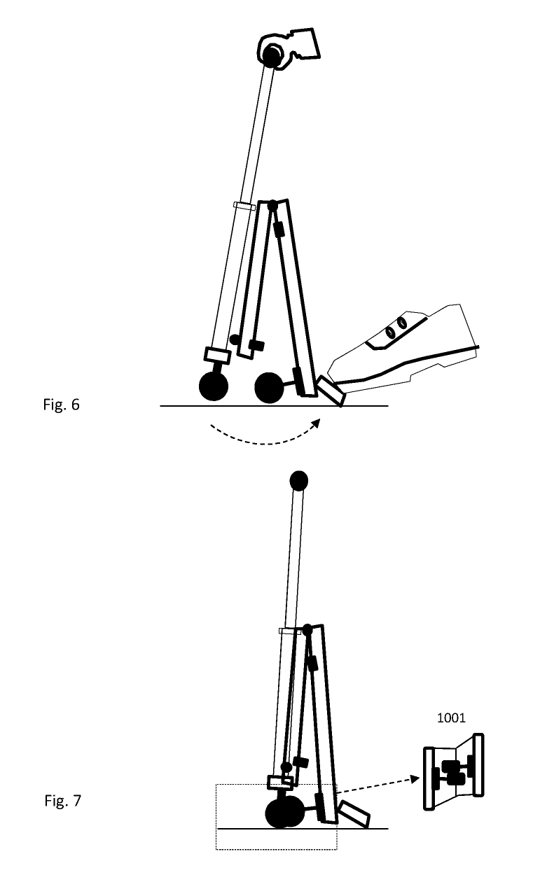

As shown in FIG. 6, by holding the steering handlebar in a fixed position, the forward and rear portions continue to fold toward one another.

Once the two portions have folded completely, as shown in FIG. 7, the front and rear wheel or wheels are now side by side (1001), with or without a small space between them, because of the angular displacement imposed by the mating edge line making an angle Φ with a line horizontal the peripheral edges and the relative position of the rear wheel on the rearward portion. Note that once in this position, the wheels and the foot folding lever and stand provide a firm upright support allowing the device embodiment to stand on its own.

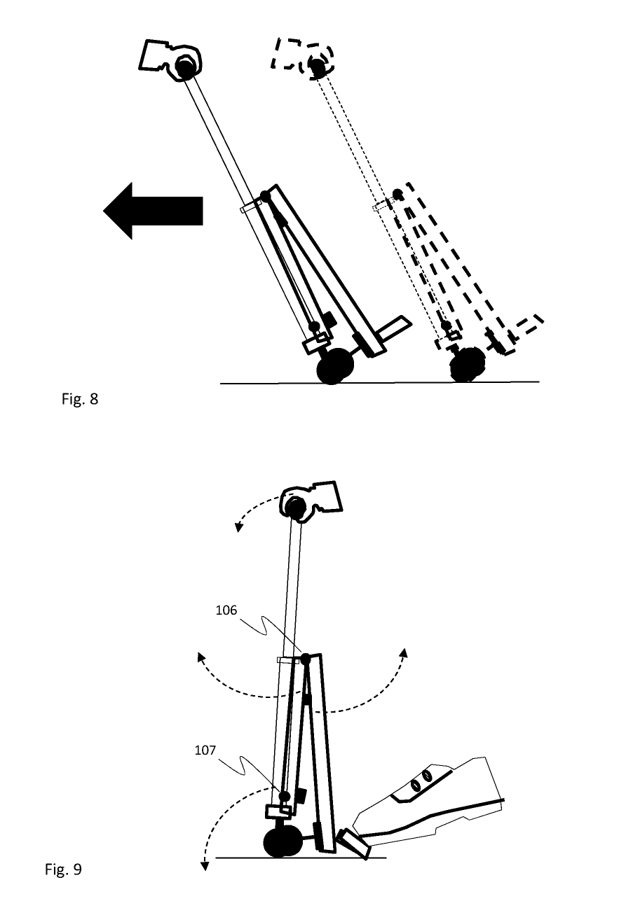

As shown in FIG. 8, the standing device can be pulled along simply by grasping the steering handlebar, tilting the device so that steering column is rotated toward the ground lifting the foot folding lever and stand up off the ground, and then pulling the device along using the steering handlebar.

Once the device is returned to its standalone upright position as shown in FIG. 9, it can be unfolded by applying pressure to the foot folding lever and stand while pushing the handlebar forward, the foot folding lever and stand will then unlock both locking subsystems Then, lightly pushing the handlebar back toward the rearward portion, the two portions unfold around the hinge and mating edges 106,. Finally, the steering column is moved forward so the platform mounting hinging subsystem enables the P₁ portion and steering column to lock into the final unfolded orientation.

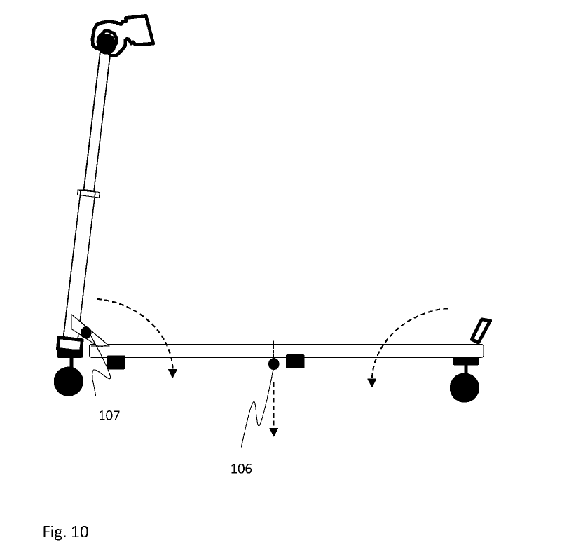

As shown in FIG. 10, the fully unfolded device embodiment will be ready to be propelled and ridden. The mating edges 106 are now flush, and the steering column is locked in it nearly vertical position.

A second embodiment of the foldable, personal, transportation device enables the folding to be done such that a platform hinging device allows the rearward portion to rotate downward after unlocking the device by putting pressure on the foot folding lever and stand. The platform portions are oriented such that they will not block one another's rotation, thus allowing the front wheel or wheels and rear wheel or wheels to align essentially side-by-side. The wheels may line up adjacent to one another or have a slight space between them. A rotation-limiting structure installed on the front portion, or on the mounting bracket, prevents the portions from rotating beyond the point where the wheels are essentially side-by-side. Note that this embodiment accommodates larger diameter front and rear wheels

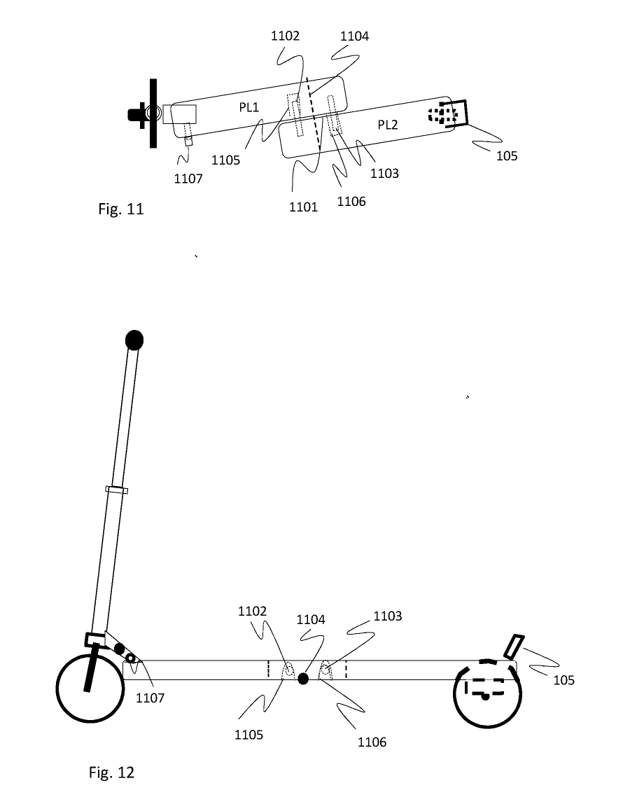

As shown in FIG. 11, the platform configuration of the second embodiment comprises two portions, a forward portion PL1 and rearward portion PL2. A platform hinging subsystem 1104 provides one point of rotation for the two portions. A first dowel-like structure, located on portion PL2 extends essentially perpendicular to its mating edge with PL1 such that when unfolded, the dowel-like structure sits snugly into a first carved-out space 1105 that creates a trench on the bottom surface of PL1 Similarly, a second dowel-like structure, located on portion PL1 extends essentially perpendicular to its mating edge with PL2 sits snugly into a second carved-out space 1106 that creates a trench on the bottom surface of PL2. When fully unfolded, the dowel-like structures now snugly in the carved-out spaces provide added support for the fully unfolded platform portions. A rotation-limiting structure 1107 located on the platform mounting bracket prevents the portions from rotating beyond the point where the wheels are essentially aligned side-by-side

In FIG. 12, a side view of the device shown in FIG. 11 is depicted. The platform hinging subsystem 1104, the dowel-like structures 1102 and 1103, and the carved-out spaces are shown.

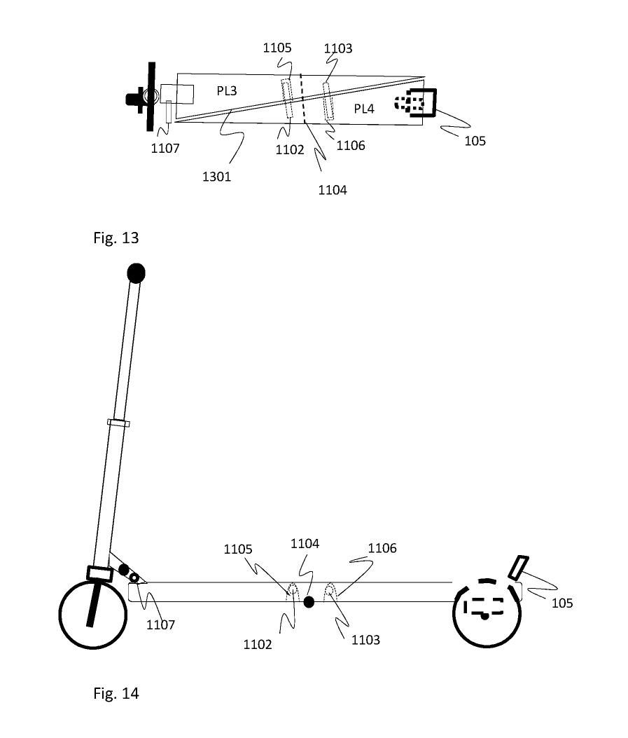

FIG. 13 shows a third embodiment of the transportation device. Here, the platform portions PL3 and PL4 interface along mating edges 1301. As in FIG. 11, dowel-like structures 1102 and 1103 fit snugly in carved-out spaces 1105 and 1106 such that when fully unfolded, the dowel-like structures now snugly in the carved-out spaces provide added support for the fully unfolded platform portions. Here, again, the platform portions are oriented so as to allow both to rotate enough for the front wheel or wheels and rear wheel or wheels to align essentially side-by-side. A rotation-limiting structure 1107 prevents the portions from rotating beyond the point where the wheels are essentially aligned side-by-side. Note that as FIG. 11 embodiment, the embodiment of FIG. 13 accommodates larger diameter front and rear wheels.

FIG. 14 is a side view of the device shown in FIG. 13. The hinging subsystem 1104, the dowel-like structures 1102 and 1103, and the carved-out spaces are shown.

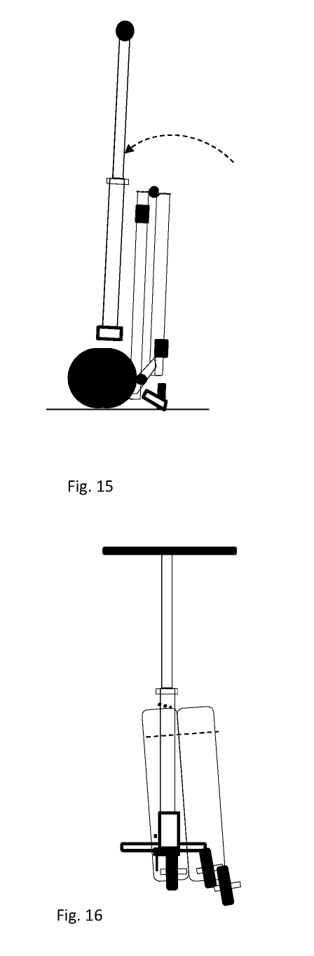

FIG. 15 shows a side view of the second and third embodiments fully folded.

FIG. 16 is a front view of the folded second embodiment of the device.

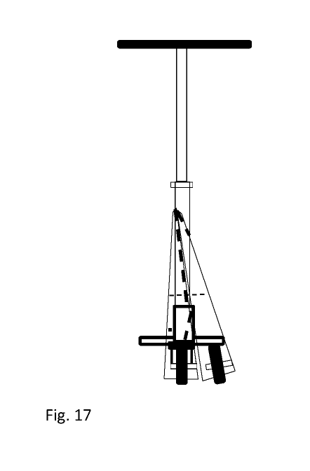

FIG. 17 is a front view of the folded third embodiment of the device.

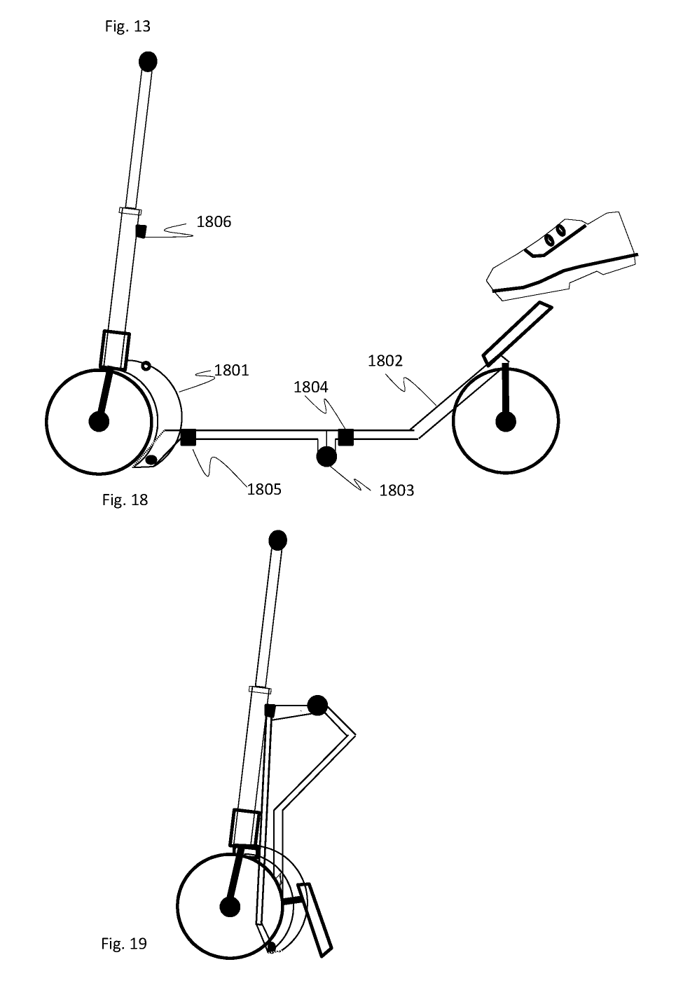

FIG. 18 illustrates an embodiment of the invention where wheel diameters are relatively long. In this case, the front edge of the forward portion does not attach to the steering column directly but attaches to an additional connecting bracket, 1801, as shown. This accommodates the large front wheel or wheels while allowing the riding platform to remain low to the ground surface. The rear riding platform portion 1802 is now angled upward as it extends to the rear wheel or wheels. That, too, allows the riding platform to remain low to the ground structure. The hinging mechanism 1803 is positioned below the platform portions, as shown, and locking mechanisms 1804 and 1805 lock the platform and platform-to-steering-column bracket when the scooter is either fully extended or fully folded. A securing mechanism, 1806, ensures that the portions remain fixed in position with the steering column when folded. As such, the locking mechanism 1805 may optionally lock the unit in folded position because the fixture 1806 may obviate the need for locking.

FIG. 19 shows a side view of the embodiment of FIG. 18 when fully folded.

The materials used for the riding platform portions must be rigid enough and strong enough to support an adult. A metal alloy, hardwood, or sufficiently strong molded materials may all be used. The steering column, steering column sleeve and steering handlebar should be made of materials that remain rigid. The platform mounting bracket should be metal alloy and strong enough to take the weight of an adult standing on the riding platform without flexing or breaking.

The platform mounting bracket's hinging subsystem should automatically lock into position when in its near upright position. Prior to folding, the locking mechanism should be unlocked using an unlocking actuator which is activated by pressure on the foot folding lever and stand. A second locking position could be employed when the steering column is folded toward the forward portion, thus keeping the folded device locked into position as it is pulled by the steering handlebar. This locking position can be unlocked by an unlocking actuator which is activated by pressure on the foot folding lever and stand.

Wheel diameter and thickness can vary. The angle, Φ, will be dependent on the wheel dimensions.

What is claimed is:

1. A foldable, personal, transportation apparatus comprising:
a platform, essentially rectangular, having a top surface, a bottom surface, peripheral side edges, a peripheral front edge, a peripheral rear edge;
said platform having a length, L, at least 15 inches long;
said platform have a width, w, at least 2 inches wide;
at least one front wheel located forward of said peripheral front edge of said platform;
at least one rear wheel located on said bottom surface near said peripheral rear edge;
said front wheel and said rear wheel located essentially mid-way between said side edges and in a line essentially parallel to said side edges, and below said bottom surface;
said platform comprising a forward potion, and a rearward portion, joined by a mating edge hinging subsystem essentially mid-way between said peripheral front edge and said peripheral rear edge;
said mating edge hinging subsystem joins said forward potion and said rearward portion along a line of mating edges that forms an angle, Φ, between said line of mating edges and a line perpendicular to said side edges;
said mating edge hinging subsystem is operative to allow said forward portion and said rearward portion to fold along said mating edges;
a length-adjustable steering column;
a steering column sleeve and platform mounting bracket;
said platform mounting bracket operative to firmly attach said steering column sleeve to said top surface of said forward portion near said peripheral front edge;
said platform mounting bracket operative to enable said steering column sleeve and said steering column to fold essentially parallel to said top surface of said forward portion and parallel to said peripheral side edges by rotating around a platform mounting bracket hinging subsystem;
a steering handlebar;
a rear platform wheel mounting subsystem;
a platform mounting locking subsystem operative to lock said steering column into a near upright position when said device is fully unfolded;
a second locking subsystem adjacent to said mating edge hinging subsystem operative to lock said forward portion and said rearward portion into a coplanar orientation when said device is fully unfolded;
a foot folding lever and stand located on said top surface of said rearward portion near said peripheral rear edge operative to initiate folding in conjunction with said steering column and said steering handle bar, and to provide a stand upon which the folded apparatus can rest after folding is completed;
said foot folding lever and stand operative to apply pressure to a first unlocking actuator operative to unlock said platform mounting locking system, and to apply pressure to a second unlocking actuator operative to unlock said second locking subsystem adjacent to said mating edge hinging subsystem.

2. A claim as in claim 1 further comprising:
said mating edge hinging subsystem operative to enable said forward portion and said rearward portion to rotate such that said bottom surfaces of said forward portion and said rearward portion will move toward one another, and said at least one front wheel and said at least one rear wheel will end up side-by-side when folded.

3. A claim as in claim 1 further comprising:
an electric motor propulsion subsystem operative to propel said apparatus by applying rotation and torque to said at least one front or rear wheel.

4. A foldable, personal, transportation apparatus comprising:
a said platform, having said top surface, said bottom surface, said peripheral side edges, said peripheral front edge, said peripheral rear edge;
said platform having a length, L, at least 15 inches long;
said platform have a width, w, at least 2 inches wide;
at least one said front wheel located forward of said peripheral front edge of said platform;
at least one said rear wheel located on said bottom surface near said peripheral rear edge;
said length-adjustable steering column;
said steering column sleeve and platform mounting bracket;
said platform comprising a forward potion, and a rearward portion, joined by a platform hinging subsystem;
said platform hinging subsystem is operative to allow said forward portion and said rearward portion to fold such that said rearward portion peripheral edge moves upward and toward said steering column;
said platform mounting bracket operative to firmly attach said steering column sleeve to said top surface of said forward portion near said peripheral front edge;
said platform mounting bracket hinging subsystem operative to allow said forward portion to fold such that its rearward end moves upward and toward said steering column;
said platform mounting bracket operative to enable said steering column sleeve and said steering column to fold essentially parallel to said top surface of said forward portion and parallel to said peripheral side edges by rotating around a platform mounting bracket hinging subsystem;
said steering handlebar;
said rear platform wheel mounting subsystem;
said platform mounting locking subsystem operative to lock said steering column into a near upright position when said device is fully unfolded;
said second locking subsystem adjacent to said mating edge hinging subsystem operative to lock said forward portion and said rearward portion into a coplanar orientation when said device is fully unfolded;
said foot folding lever and stand located on said top surface of said rearward portion near said peripheral rear edge operative to initiate folding in conjunction with said steering column and said steering handle bar, and to provide a stand upon which the folded apparatus can rest after folding is completed;
said foot folding lever and stand operative to apply pressure to a first unlocking actuator operative to unlock said platform mounting locking system, and to apply pressure to a second unlocking actuator operative to unlock said second locking subsystem adjacent to said mating edge hinging subsystem.

5. A claim as in claim 4 further comprising:
said platform hinging subsystem operative to enable said forward portion and said rearward portion to rotate such that said top surfaces of said forward portion and said rearward portion will move toward one another, and said at least one front wheel and said at least one rear wheel will end up side-by-side when folded.

6. A claim as in claim 4 further comprising:
said electric motor propulsion subsystem operative to propel said apparatus by applying rotation and torque to said at least one front or rear wheel.
